(19) United States
(12) Patent Application Publication
(10) Pub. No.: US 2025/0350747 A1
(43) Pub. Date: Nov. 13, 2025

(54) A METHOD, AN APPARATUS AND A COMPUTER PROGRAM PRODUCT FOR ENCODING AND DECODING OF DIGITAL MEDIA CONTENT

(71) Applicant: Nokia Technologies Oy, Espoo (FI)

(72) Inventors: Alireza AMINLOU, Tampere (FI); Jani LAINEMA, Tampere (FI)

(21) Appl. No.: 18/871,219

(22) PCT Filed: Mar. 21, 2023
(86) PCT No.: PCT/FI2023/050161

§ 371 Date: Dec. 3, 2024

(30) Foreign Application Priority Data
Jun. 7, 2022 (FI) 20225498

(51) Int. Cl. H04N 19/189; G06F 17/17; H04N 19/172

(52) U.S. Cl. CPC H04N 19/189; G06F 17/17; H04N 19/172

(57) ABSTRACT

The embodiments relate to a method for encoding/decoding, the method comprising encoding/decoding (910) a picture comprising a number of samples, wherein a phase of the encoding/decoding comprises a division operation; determining (920) a numerator and a denominator; determining (930) an approximated output for the division operation between the numerator and the denominator, wherein the determining comprises deriving a scale parameter using a piecewise approximation; deriving a shift parameter and a rounding parameter, and applying the scale parameter, the shift parameter, and the rounding parameter to the numerator; using (940) the approximated output for the division operation in said phase of the encoding/decoding. The embodiments also relate to an apparatus and a computer program product for implementing the method.

### TECHNICAL FIELD

The present solution generally relates to encoding and decoding of digital media content, such as video or still image data.

### BACKGROUND

This section is intended to provide a background or context to the invention that is recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

A video coding system may comprise an encoder that transforms an input video into a compressed representation suited for storage/transmission and a decoder that can uncompress the compressed video representation back into a viewable form. The encoder may discard some information in the original video sequence in order to represent the video in a more compact form, for example, to enable the storage/transmission of the video information at a lower bitrate than otherwise might be needed.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for encoding/decoding a picture comprising a number of samples, wherein a phase of the encoding/decoding comprises a division operation; means for determining a numerator and a denominator; means for determining an approximated output for the division operation between the numerator and the denominator, wherein the means for determining comprises
means for deriving a scale parameter using a piecewise approximation,
means for deriving a shift parameter and a rounding parameter, and
means for applying the scale parameter, the shift parameter, and the rounding parameter to the numerator;
   means for using the approximated output for the division operation in said phase of the encoding/decoding.

According to a second aspect, there is provided a method, comprising: encoding/decoding a picture comprising a number of samples, wherein a phase of the encoding/decoding comprises a division operation; determining a numerator and a denominator; determining an approximated output for the division operation between the numerator and the denominator, wherein the determining comprises
deriving a scale parameter using a piecewise approximation,
deriving a shift parameter and a rounding parameter, and
applying the scale parameter, the shift parameter, and the rounding parameter to the numerator;
   using the approximated output for the division operation in said phase of the encoding/decoding.

According to a third aspect, there is provided an apparatus comprising at least one processor, memory including computer program code, the memory and the computer program code configured to, with the at least one processor, cause the apparatus to perform at least the following: encode/decode a picture comprising a number of samples, wherein a phase of the encoding/decoding comprises a division operation; determine a numerator and a denominator; determine an approximated output for the division operation between the numerator and the denominator, wherein the apparatus is further caused to
derive a scale parameter using a piecewise approximation,
derive a shift parameter and a rounding parameter, and
apply the scale parameter, the shift parameter, and the rounding parameter to the numerator;
   use the approximated output for the division operation in said phase of the encoding/decoding.

According to a fourth aspect, there is provided computer program product comprising computer program code configured to, when executed on at least one processor, cause an apparatus or a system to:

encode/decode a picture comprising a number of samples, wherein a phase of the encoding/decoding comprises a division operation; determine a numerator and a denominator; determine an approximated output for the division operation between the numerator and the denominator, wherein the apparatus is further caused to
derive a scale parameter using a piecewise approximation,
derive a shift parameter and a rounding parameter, and
apply the scale parameter, the shift parameter, and the rounding parameter to the numerator;
   use the approximated output for the division operation in said phase of the encoding/decoding.

According to an embodiment, said phase of the encoding/decoding comprises predicting at least one sample of the picture.

According to an embodiment, said phase of the encoding/decoding comprises filtering.

According to an embodiment, an additional shift parameter is applied to the numerator.

According to an embodiment, it is determined when the numerator, denominator, scale parameter and output parameter have different bit precision, whereupon the bit precision of the output and the scale parameter are used when determining the approximated output.

According to an embodiment, the scale parameter is determined using one of the following: an interpolation operation; a polynomial process; a linear interpolation.

According to an embodiment, the scale parameter is determined using theinterpolation operation between at least two values which are determined based on a table look-up.

According to the embodiment, the scale parameter is adjusted with a value to reduce a range of the denominator.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of an encoding process;

FIG. 2 shows an example of a decoding process;

FIG. 3 shows an example of a look-up table with values M=14 and N=8;

FIG. 4 shows an example of a look-up table with values M=12 and N=8;

FIG. 5 shows an example of a look-up table with values M=14 and N=6;

FIG. 6 shows an example of a look-up table with values M=14 and N=2;

FIGS. 7a, 7b show an example of a linear regression model calculated for values M=14 and N=2;

FIG. 8 is a flowchart illustrating a method according to an embodiment;

FIG. 9 is a flowchart illustrating a method according to another embodiment; and

FIG. 10 shows an apparatus according to an embodiment.

### DESCRIPTION OF EXAMPLE EMBODIMENTS

In the following, several embodiments will be described in the context of one video coding arrangement. It is to be noted, however, that the present embodiments are not necessarily limited to this particular arrangement. The embodiments discussed in this specification relates to intra prediction in video or still image coding using sparse linear cross-component regression and it can be even a signal processing other than image/video compression.

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment in included in at least one embodiment of the disclosure.

Video codec comprises an encoder and a decoder. The encoder is configured to transform input video into a compressed representation suitable for storage/transmission. The decoder is able to decompress the compressed video representation back into a viewable form. The encoder may discard some information in the original video sequence in order to represent the video in a more compact form, for example at a lower bitrate.

An elementary unit for the input to an encoder and the output of a decoder, respectively, in most cases is a picture. A picture given as an input to an encode may also be referred to as a source picture, and a picture decoded by a decoder may be referred to as a decoded picture or a reconstructed picture.

The source and decoded picture are each comprised of one or more sample arrays, such as one of the following sets of sample arrays:
Luma (Y) only (monochrome);
Luma and two chroma (YCbCr or YCgCo);
Green, Blue and Red (GBR, also known as RGB);
Arrays representing other unspecified monochrome or tri-stimulus color samplings (for example, YZX, also known as XYZ).

A picture may be defined to be either a frame or a field. A frame comprises a matrix of luma samples and possibly the corresponding chroma samples. A field is a set of alternate sample rows of a frame, and may be used as encoder input, when the source signal is interlaced. Chroma sample arrays may be absent (and hence monochrome sampling may be in use) or chroma sample arrays may be subsampled when compared to luma sample arrays.

A bitstream may be defined as a sequence of bits, which may in some coding formats or standards be in the form of a network abstraction layer (NAL) unit stream or a byte stream, that forms the representation of coded pictures and associated data forming one or more coded video sequence. A first bitstream may be followed by a second bitstream in the same logical channel, such as in the same file or in the same connection of a communication protocol. An elementary stream (in the context of video coding) may be defined as a sequence of one or more bitstreams. In some coding formats or standards, the end of the first bitstream may be indicated by a specific NAL unit, which may be referred to as the end of the bitstream (EOB) NAL unit and which is the last NAL unit of the bitstream.

The phrase “along the bitstream” (e.g., indicating along the bitstream) or along a coded unit of a bitstream (e.g., indicating along a coded tile) may be used in claims and described embodiments to refer to transmission, signaling or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signalling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Hybrid video codecs, for example ITU-T H.263 and H.264 may encode video information in two phases. At first, pixel values in a certain picture area (or “block”) are predicted for example by motion compensation means (finding and indicating an area in one of the previously coded video frames that correspond closely to the block being coded) or by spatial means (using the pixel values around the block to be coded in a specified manner). In the first phase, predictive coding may be applied, for example, as so-called sample prediction and/or so-called syntax prediction. In the sample prediction, pixel of sample values in a certain picture area or “block” are predicted. These pixel or sample values can be predicted, for example, using one or more of motion compensation or intra prediction mechanism. Secondly, the prediction error, i.e., the difference between the predicted block of pixels and the original bock of pixels is coded. This may be done by transforming the difference in pixel values a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

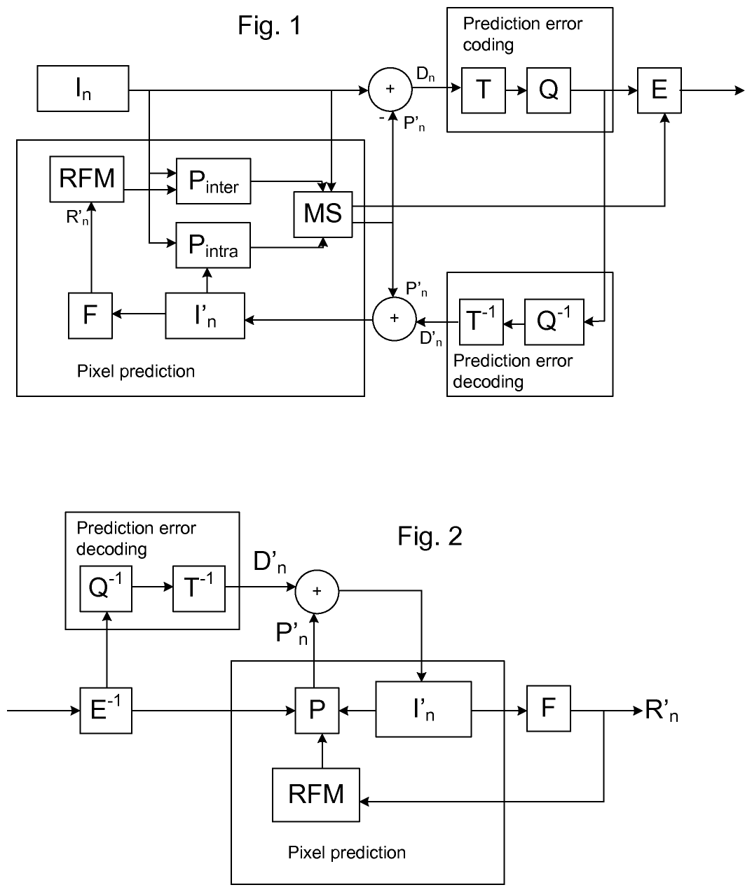

The example of the encoding process is illustrated in FIG. 1. FIG. 1 illustrates an image to be encoded (Iₙ); a predicted representation of an image block (P′ₙ); a prediction error signal (Dₙ); a reconstructed prediction error signal (D′ₙ); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F).

In some video codecs, such as H.265/HEVC, video pictures are divided into coding units (CU) covering the area of the picture. A CU comprises one or more prediction units (PU) defining the prediction process for the samples within the CU and one or more transform units (TU) defining the prediction error coding process for the samples in said CU. A CU may comprise a square block of samples with a size selectable from a predefined set of possible CU sizes. A CU with the maximum allowed size may be named as LCU (largest coding unit) or CTU (coding tree unit), and the video picture may be divided into non-overlapping CTUs. A CTU can be further split into a combination of smaller CUs, e.g., by recursively splitting the CTU and resultant CUs. Each resulting CU may have at least one PU and at least one TU associated with it. Each PU and TU can be further split into smaller PUs and TUs in order to increase the granularity of the prediction and prediction error coding processes, respectively. Each PU has prediction information associated with it, defining what kind of a prediction is to be applied for the pixels within that PU (e.g., motion vector information for inter predicted PUs and intra prediction directionality information for intra predicted PUs). Similarly, each TU is associated with information describing the prediction error decoding process for the samples within said TU (including e.g., DCT coefficient information). It may be signalled at CU level, whether prediction error coding is applied or not for each CU. In the case there is no prediction error residual associated with the CU, it can be considered there are no Tus for said CU. The division of the image into CUs, and division of CUs into PUs and TUs may be signaled in the bitstream allowing the decoder to reproduce the intended structure of these units.

The decoder may reconstruct the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder is configured to sum up the prediction and prediction error signals (pixel values) to form the output video frame. The decoder (and encoder) can also apply additional filtering means to improve the quality of the output video before passing it for display and/or storing it as prediction reference for the forthcoming frames in the video sequence. An example of a decoding process is illustrated in FIG. 2. FIG. 2 illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

Instead, or in addition to approaches utilizing sample value prediction and transform coding for indicating the coded sample values, a color palette-based coding can be used. Palette based coding refers to a family of approaches for which a palette, i.e., a set of colours and associated indexes, is defined and the value for each sample within a coding unit is expressed by indicating its index in the palette. Palette based coding can achieve good coding efficiency in coding units with a relatively small number of color (such as image areas which are representing computer screen content, for example text or simple graphics). In order to improve the coding efficiency of palette coding, different kinds of palette index prediction approaches can be utilized, or the palette indexes can be run-length coded to be able to represent larger homogenous areas efficiently. Also, in the case the CU contains sample values that are not recurring within the CU, escape coding can be utilized. Escape coded samples are transmitted without referring to any of the palette indexes. Instead, their values may be indicated individually for each escape coded sample.

When a CU is coded in palette mode, the correlation between pixels within the CU is exploited using various prediction strategies. For example, mode information can be signaled for each row or pixels that indicates one of the following: the mode can be horizontal mode meaning that a single palette index is signaled and the whole pixel line shares this index; the mode can be vertical mode, where the whole pixel line is the same with the above line, and no further information is signaled; the mode can be normal mode where a flag is signaled for each pixel position to indicate whether it is the same with one of the left and other pixels—and if not, the color index itself is separately transmitted.

In video codecs, the motion information may be indicated with motion vectors associated with each motion compensated image block. Each of these motion vectors may represent the displacement of the image block in the picture to be coded (at the encoder side) or decoded (at the decoder side), and the prediction sources block in one of the previously coded or decoded pictures. In order to represent motion vectors efficiently, those may be coded differentially with respect to block specific predicted motion vectors. In video codecs, the predicted motion vectors may be created in a predefined way, for example calculating the media of the encoder or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, the reference index of previously coded/decoded picture can be predicted. The reference index may be predicted from adjacent blocks and/or co-located blocks in temporal reference picture. Moreover, high efficiency video codecs may employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information may be signaled among a list of motion field candidate list filled with motion field information of available adjacent/co-located blocks.

Video codecs may support motion compensated prediction from one source image (uni-prediction) and two sources (bi-prediction). In the case of uni-prediction, a single motion vector may be applied whereas in the case of bi-prediction, two motion vectors may be signaled and the motion compensated predictions from two sources may be averaged to create the final sample prediction. In the case of weighted prediction, the relative weights of the two predictions can be adjusted, or a signaled offset can be added to the prediction signal.

In addition to applying motion compensation for inter picture prediction, similar approach can be applied to intra picture prediction. In this case the displacement vector indicates where a block of samples can be copied from the same picture to form a prediction of the block to be coded or decoded. This kind of intra block copying methods can improve the coding efficiency substantially in presence of repeating structures within the frame-such as text or other graphics.

In video codecs, the prediction residual after motion compensation or intra prediction may be first transformed with a transform kernel (like DCT “Discrete-Cosine Transform”) and then coded. The reason for this is that often there still exists some correlation among the residual and transform can in many cases help reduce this correlation and provide more efficient coding.

Video encoders may utilize Lagrangian cost functions to find optimal coding modes, e.g., the desired macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Eq . 1 )$$

where C is the Lagrangian cost to be minimized, D is the image distortion (e.g., Mean Squared Error) with the mode and motion vectors considered, and R is the number or bits needed to represent the required data to reconstruct the image block in the decoder (including the amount of data to represent the candidate motion vectors).

Scalable video coding refers to coding structure where one bitstream can contain multiple representation of the content at different bitrates, resolutions, or frame rates. In these cases, the receiver can extract the desired representation depending on its characteristics (e.g., resolution that matches best the display device). Alternatively, a server or a network element can extract the portions of the bitstream to be transmitted to the receiver depending on e.g., the network characteristics or processing capabilities of the receiver. A scalable bitstream may comprise a “base layer” providing the lowest quality video available and one or more enhancement layers that enhance the video quality when received and decoded together with the lower layers. In order to improve the coding efficiency for the enhancement layers, the coded representation of that layer may depend on the lower layers. E.g., the motion and mode information of the enhancement layer can be predicted from lower layers. Similarly, the pixel data of the lower layers can be used to create prediction for the enhancement layer.

A scalable video codec for quality scalability (also known as Signal-to-Noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In H.264/AVC, HEVC, and similar codec using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and may indicate its use with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

In addition to quality scalability, following scalability modes exist:
Spatial scalability: Base layer pictures are coded at a lower resolution than enhancement layer pictures.
Bit-depth scalability: Base layer pictures are coded at lower bit-depth (e.g., 8 bits) than enhancement layer picture (e.g., 10 or 12 bits).
Chroma format scalability: Enhance layer picture provide higher fidelity in chroma (e.g., coded in 4:4:4 chroma format) than base layer picture (e.g., 4:2:0 format).

In the aforementioned scalability cases, base layer information can be used to code enhancement layer to minimize the additional bitrate overhead.

Scalability can be enabled in two ways: a) by introducing new coding modes for performing prediction of pixel values or syntax from lower layers of the scalable representation; or b) by placing the lower layer pictures to the reference picture buffer (decoded picture buffer, DPB) of the higher layer. Approach a) is more flexible, and thus can provide better coding efficiency in most cases. However, the approach b), i.e., the reference frame-based scalability, can be implemented very efficiently with minimal changes to single layer codecs while still achieving majority of the coding efficiency gains available. A reference frame-based scalability codec can be implemented by utilizing the same hardware or software implementation for all the layers, just taking care of the DPB management by external means.

In order to be able to utilize parallel processing, images can be split into independently codable and decodable image segments (slices or tiles). Slices may refer to image segments constructed of certain number of basic coding units that are processed in default coding or decoding order, while tiles may refer to image segments that have been defined as rectangular image regions that are processed at least to some extent as individual frames.

A video may be encoded in YUV or YCbCr color space that is found to reflect some characteristics of the human visual system and allows using lower quality representation for Cb and Cr channels as human perception is less sensitive to the chrominance fidelity those channels represent.

Different parts of video codecs may require usage of division operation or an approximation of such operation. For example, in Versatile Video Coding (VVC/H.266) standard, a Cross-Component Linear Model (CCLM) is used as a linear model for predicting the samples in the chroma channels (e.g., Cb and Cr) based on reconstructed luma samples. The prediction model of CCLM can be

$${pred}_{C} ( i , j ) = α \cdot {rec}_{L}^{′} ( i , j ) + β$$

where pred_{C}(i, j) represents the predicted chroma samples in a coding unit and rec_{L}′(i, j) represents the downsampled reconstructed luma samples of the same coding unit.

The parameters α and β are derived with at most four neighbouring chroma samples and their corresponding down-sampled luma samples as follows:

$$\begin{matrix}α = \frac{{Y}_{a} - {Y}_{b}}{{X}_{a} - {X}_{b}} \\ β = {Y}_{b} - α \cdot {X}_{b}\end{matrix}$$

Thus, when calculating the CCLM parameters, division operations are generally required. The division operation can be implemented with a look-up table.

On the other hand, in cross-component convolutional model (CCCM) division operations are also generally required when filtering prediction coefficients.

The division operation is a relatively complex operation to implement and requires extra logic circuitry on a hardware based video codec implementation or extra cycles for executing a division operation in a software based implementation running on a general purpose processor.

The division operation required by the cross-component linear model prediction (CCLM) used for example in the VVC/H.266 and ECM 3.0 video codecs uses a table look-up based approach to approximate a division operation. In this approach a 2\hat{ }4=16 entry look-up table is used to derive 4 bit significant values which approximate inverse of the input at 1/2\hat{ }4 precision.

The present embodiments are targeted to determine scale and shift values which can be used to approximate division operation for example in video coding applications. The method comprises decoupling the precision of the entries and the size of the look-up table used to generate approximate inverses for input data. As a result, the size of the look-up table is configured to be smaller than 2\hat{ }M entries when the look-up table is used to derive M-bit significant values. Significant values for the intermediate entries are not included in the table but derived either by rounding to existing entries in the table or interpolated using a set of existing entries in the look-up table. Both rounding to existing entries and interpolation between the existing entries provide a piecewise representation of the relationship between the input and the output scale values.

An alternative method to derive the values for entries is to use polynomial (e.g., power of 2) function. In particular, it is shown that if form of the polynomial function and its parameters are selected carefully, the implementation of the polynomial function with low bit precision integer arithmetic generates accurate results with minimum effect of parameter quantization error. This allows a video encoder or a video decoder to generate high precision estimates for results of a division operation with minimal computational burden and minimal memory requirements for the look-up table(s) needed. The performance can be further enhanced by using different approximations for different segments of input values creating a piecewise model where each segment has their own polynomial function.

A method operating according to the invention determines an approximated output for a division operation using an under-sampled look-up table. That is, the intention is to calculate output value which closely represents result of a division operation between numerator nom and denominator denom:

$$output \approx nom / denom$$

by using simpler operations, such as multiplications, additions and bitwise shifting operations. Therefore, the present embodiments provide a division free inverse function. In general, the output is approximated by deriving scale, rounding and shift parameters such that the output can be calculated as:

$$output = ( nom * scale + round ) ≫ shift$$

In the case the input (nom and denom) and output of the operation are using a fixed point arithmetic, there can be additional shifting of nom value to align the decimal bits of input and output:

$$output = ( ( nom ≪ shiftDecim ) * scale + round ) ≫ shift$$

In such case the value of shiftDecim can be configured to be a function of the number of bits used to represent the decimal part of the numbers. The value of shiftDecim can also depend on other parameters, such as the precision of the scale value used in the equation.

The rounding parameter round in the equations can be used to improve the accuracy of the calculation and can be set for example as follows:

$$\begin{matrix}round = 1 ≪ shift ≫ 1 , or \\ round = 1 ≪ ( shift - 1 ) , or \\ round = 0\end{matrix}$$

In general case, where nom, denom, scale and output parameters have different bit precision, the output value may be calculated using following equation where N_output and N_scale is bit precision or number of bits to represent the decimal part of the number of output and scale parameters, respectively. And round parameter is calculated using (shift+N_scale)

$$output = ( ( nom ≪ ( N\_denom + N\_output ) ) * scale + round ) ≫ ( shift + N\_scale + N\_nom )$$

$$round = 1 ≪ ( shift + N\_scale + N\_nom - 1 )$$

An alternative method to calculate output is as follow:

$$delta\_shift = ( shift + N\_scale + N\_nom ) - ( N\_denom + N\_output )$$

$$output = ( delta\_shift > 0 ) ? ( nom * scale + round ) ≫ ( delta\_shift ) : ( nom * scale + round ) ≪ ( delta\_shift )$$

$$round = ( delta\_shift > 0 ) ? 1 ≪ ( delta\_shift - 1 ) : 0$$

If setting scale equal to zero, it can naturally be omitted from the equations leading into somewhat less accurate results, but also in some savings in number of operations required to calculate the output value.

The shifting parameter shift can be configured in different ways. For example, it can be set equal to the logarithm of two of the denominator denom. The logarithm of two can be configured to be rounded downwards to the closest integer value. Alternatively, it can be rounded to the closest integer value or upwards to the closest integer value. Alternatively, the shift can be configured to include also a term associated with the precision of the scale parameter. For example, if the scale parameter is represented by an integer of M bits, the shift parameter can be configured to compensate for that by adding M to the logarithm of two of the denominator.

$$\begin{matrix}shift = floorLog 2 ( denom ) , or \\ shift = floorLog 2 ( denom ) + M\end{matrix}$$

where floorLog2 is a function returning closest integer smaller or equal to the logarithm of two of the input parameter denom.

The scale value can be determined in different ways. One alternative is to use a look-up table representing values between one and half in M-bit (or N_scale-bit) precision.

That is, a table where a value 2\hat{ }M represents one and 2\hat{ }(M−1) represents half for the selected M. As the values in such range vary between 2\hat{ }(M−1) and 2\hat{ }M, the values in the table can optionally be reduced by 2\hat{ }(M−1) to lower the storage bitdepth required by the table. In that case, when reading the values from the table 2\hat{ }(M−1) can be added back to the read value to recover the values in full range. Such addition can also be performed by a bitwise “or” operation between a value read from the table and the value of 2\hat{ }(M−1).

The size of the table is selected to have a size smaller than 2\hat{ }M in order to be able to operate with small amount of memory compared to a full sized table with 2\hat{ }M entries. For example, a table of size 2\hat{ }N or (2\hat{ }N)+1 can be selected, where N<M. The difference D between the table entry precision parameter M and the table size parameter N represents the subsampling ratio between a “full” 2\hat{ }M table typically required for M-bit scale values and the actual table size 2\hat{ }N. Setting:

$$D = M - N$$

the subsampling ratio 2\hat{ }(M−N) between the tables can be given as 2\hat{ }D.

Entries in such look-up table can be determined, for example, as using the following pseudo-code:

```
D = M − N
d = 1 << M
index = 0
while d <= (2 << M)
{
  table[index] = round( double( 1 << (2*M) ) / double( d ) )
  index += 1
  d += 1 << D
}
```

Where << is used to denote a bitwise left shift operation and x+=y is used to denote adding value of y to the value of x. double(x) is used to denote casting an integer to a double precision floating point number and round(x) is representing rounding to the nearest integer value.

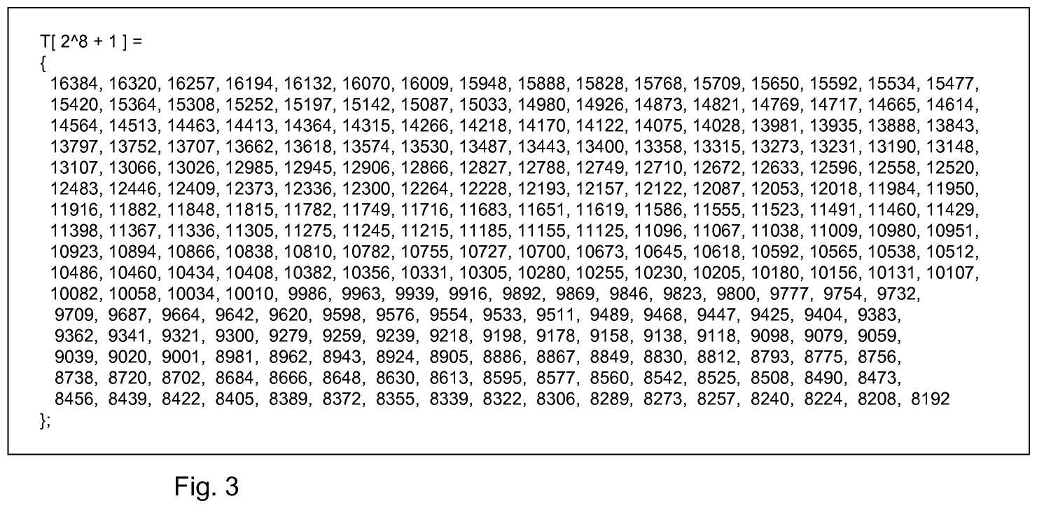

As a result the look-up table T could have for example the values (with M=14 and N=8) as presented in FIG. 3.

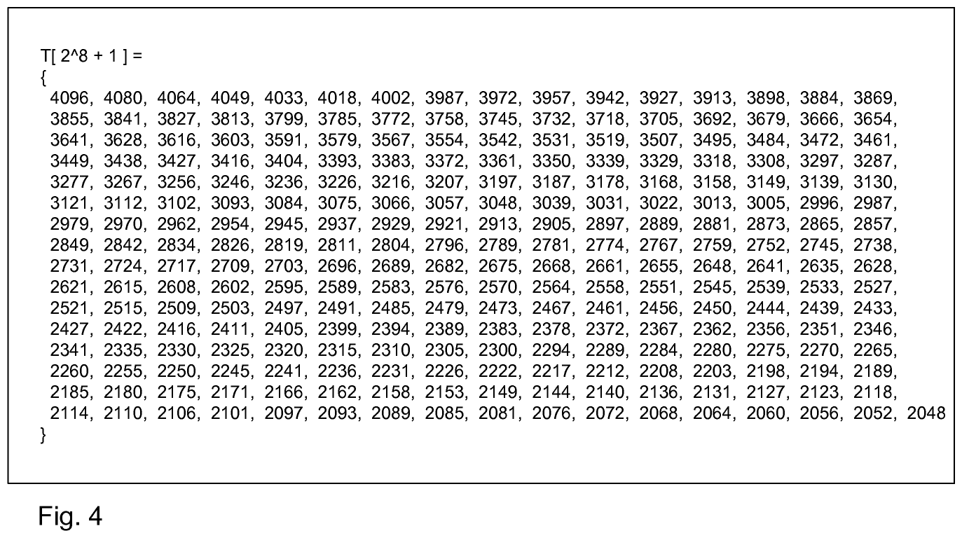

In another example of the case, values M=12 and N=8 are selected, whereupon the look-up table T would be as shown in FIG. 4.

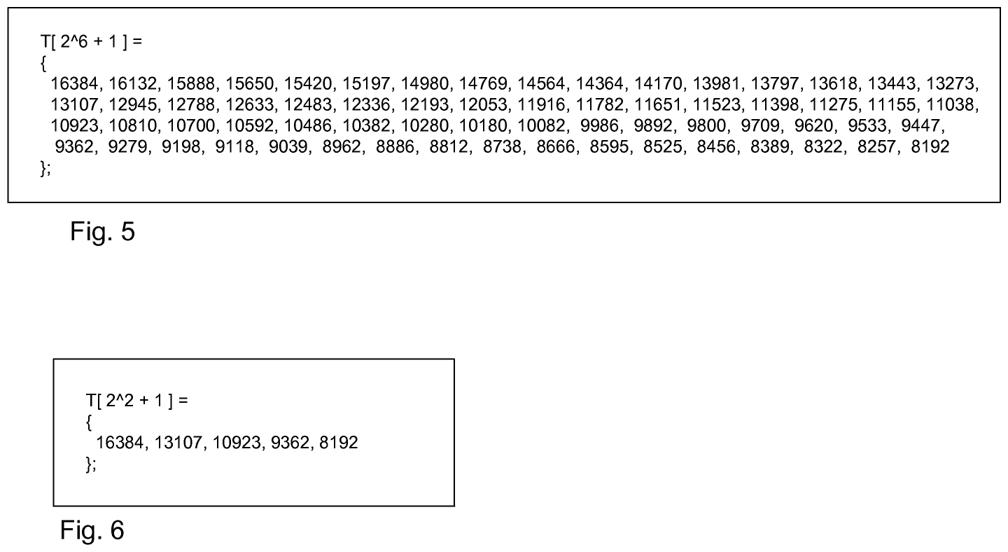

As a further example, selecting M=14 and N=6, the look-up table T can be configured for example as shown in FIG. 5.

As a further example, selecting M=14 and N=2, the look-up table T can be configured for example as shown in FIG. 6.

It is appreciated that different parameters of M and N can be used, as well as different algorithms to generate such look-up tables. For example, different rounding approaches can be used, or different precisions of calculations can be used to determine values in the look-up table.

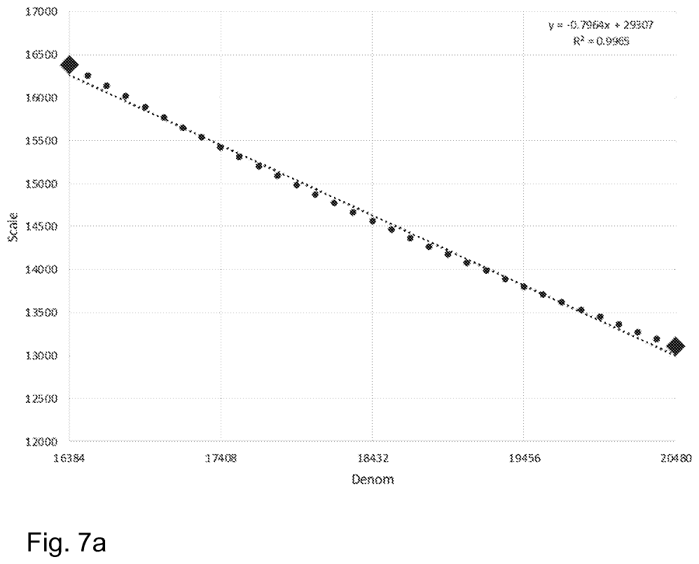

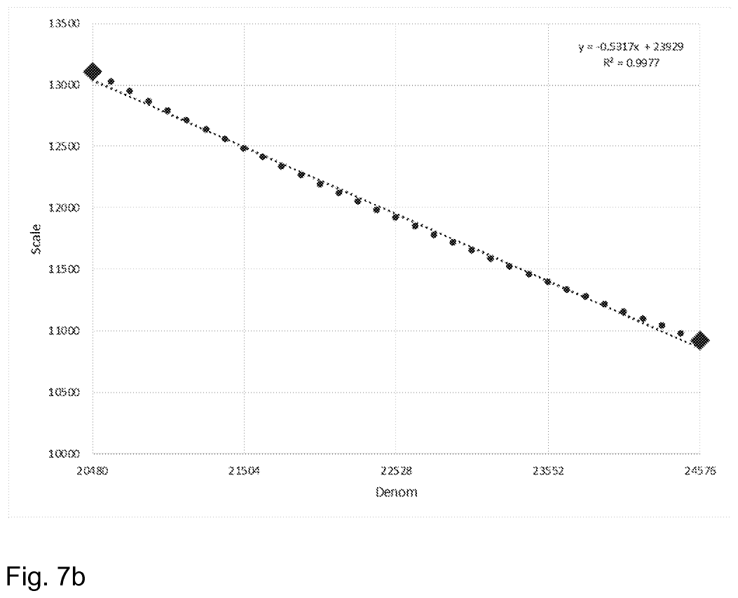

An alternative way to calculate entries in that look-up table is to use linear regression. Between to entries of look-up table, there are missing 2\hat{ }D−1 scale values. In other words, there are missing 2\hat{ }D−1 scale values before and after each entry. Thus, a linear regression model may be calculated for each side of each entry, then value of that entry point may be evaluated based on those two regression models to calculate two values. Then the value of that entry may be set to average of those two values. for example, when M=14 and N=2, there are four pieces, and the regression model for the first and the second pieces are shown in FIG. 7a and FIG. 7b, respectively. The value of the second entry using the first and the second regression model is evaluated to be 12996.72 (i.e., −0.7964*20480+29306.85) and 13039.67 (i.e., −0.5317*20480+23929.43) respectively. Then the final value of that entry may be average of these two values, i.e., which is truncated to (12996.72+12996.72)/2=13018.12, which may be truncated to 13018. This value is a bit lower than the value created using the previous method (i.e., 13107). As a result of this method, the look-up table T can be configured for example as follows:

T[ 2 \hat{ } 2 + 1 ] =
{
16259, 13018, 10872, 9331, 8168
};

A table constructed in such way represents scale values subsampled by a factor of 2\hat{ }D, the missing 2\hat{ }D−1 scale values between the ones included in the table can be determined using interpolation. Alternatively, to achieve lower complexity but with lower precision of the output, the denominator can be mapped to the closest available entry in the table or closest available entry in the table with rounding down. Using linear 2-tap interpolation an approximate output for a division operation between numerator nom and denominator denom can be determined, for example, as follows:

```
// Stage 1
  shift0 = floorLog2( denom )
  round0 = 1 << shift0 >> 1
  normDiff = ( ( (denom << M ) + round0) >> shift0) & ((1 << M) − 1);
// Stage 2
  D = M − N
  diffFull = normDiff>> D
  diffFrac = normDiff & ( (1 << D ) − 1)
  tapRound = 1 << D >> 1
  scale0 = T[diffFull]
  scale1 = T[diffFull + 1]
  scale = scale0 + ( ( diffFrac * ( scale1 − scale0 ) + tapRound ) >> D )
// Stage 3
  output = ( (nom << (FP_BITS − M)) * scale + round0) >> shift0
```

In this case the sequence of operations can be considered to have three stages as indicated above. In stage 1 the shift0 and normDiff parameters are determined. This represents a tabulation of the input denominator denom to a range of data. The normDiff parameter is configured to map the denominator denom to the precision of the table entry precision parameter M. In stage 2 the normDiff is split into a full entry parameter diffFull and a fractional entry parameter diffFrac. Full entry parameter diffFull is used to identify entries in the table T and fractional entry parameter diffFrac is used to determine the final scale parameter based on the entries read from table T or parameters generated based on entries read from table T. Parameters scale0 and scale1 are determined using table T at entry positions diffFull and diffFull+1, respectively. The final scale parameter scale is then calculated based of scale0, scale1 and the fractional entry part diffFrac using linear interpolation. In final stage 3, the output is calculated based on the scale, round and shift parameters. If using a fixed point representation with number of decimal bits given as FP_BITS, the numerator nom can be adjusted here by shifting left with (FP_BITS−M) before multiplying by scale. Alternatively, the final shift value can be set to shift0+M, and the final rounding parameter can be calculated based on the new final shift. In this kind of alternative, the output in stage 3 can be determined as:

$$\begin{matrix}// Stage 3 , alternative 1 \\ shift = shift 0 + M \\ round = 1 ≪ shift ≫ 1 \\ output = ( ( nom ≪ FP\_BITS ) * scale + round ) ≫ shift\end{matrix}$$

Or if the calculation is not using a fixed point representation, it can be further simplified, for example, to:

$$\begin{matrix}// Stage 3 , alternative 2 \\ shift = shift 0 + M \\ round = 1 ≪ shift ≫ 1 \\ output = ( ( nom * scale + round ) ≫ shift\end{matrix}$$

In all these examples the roundings could naturally be configured to be done differently. For example, the parameter round or round0 could be set to 0, or it could be set to another value derived using the shift or other parameters.

The interpolation in stage 2 can also be performed differently. For example, it can include more than two entries from table T in the calculation with different coefficients based on the value of diffFrac. It can also be performed calculating a weighed sum of the entries read from table Tor parameters derived from values in table T, for example, as follows:

```
// Stage 2, alternative 1
  D = M − N
  diffFull = normDiff >> D
  diffFrac = normDiff & ( (1 << D ) − 1)
  tapSum = 1 << D
  tapRound = 1 << D >> 1
  scale0 = T[diffFull]
  scale1 = T[diffFull + 1]
  w0 = tapSum − diffFrac
  w1 = diffFrac
  scale = ( w0 * scale0 + w1 * scale1 + tapRound ) >> D
```

Instead of or in addition to the interpolation operation used in stage 2 to refine the scale value, alternative approaches, such as methods based on the derivatives of the scale function can be used.

As a further simplified approach, the interpolation done in stage 2 can be omitted. In this case the table size parameter N can be advantageously used during stage 1 calculation of normDiff parameter, and the table entry precision parameter M can be used only in determining the final shift and the optional rounding parameter. This example can be illustrated as pseudo-code as follows:

shift0 = floorLog2( denom )
round0 = 1 << shift0 >> 1
normDiff = ( ( ( denom << N ) + round0 ) >> shift0) & ((1 << N) − 1)
scale = T[normDiff]
shift = shift0 + M
round = 1 << shift >> 1
output = ( nom * scale + round) >> shift

Again, if operating using fixed point numbers with decimal bits given as FP_BITS, the final shift can be made equal to floorLog2(denom) and the effect of decimal point can be handled as part of the scaling of numerator nom as follows:

$$\begin{matrix}shift = floorLog 2 ( denom ) \\ round = 1 ≪ shift ≫ 1 \\ normDiff = ( ( ( denom ≪ N ) + round ) ≫ shift ) \& ( ( 1 ≪ N ) - 1 ) \\ scale = T [ normDiff ]\end{matrix}$$

In the case the same division operation using the same denominator needs to be performed for several different numerators, it is enough to calculate the scale and shift values once are reuse those when performing the division operation. This way the number of computational operations can be significantly reduced as most of the operations required are related to calculating the scale and shift values and the actual operation of calculating the output only requires multiplication with the scale and shifting with shift, in addition to optional additional shifting and rounding.

An alternative way to calculate scale is to use piecewise polynomial estimation or polynomial interpolation. In this case, the range of input data is divided into multiple regions (e.g., 4 or 8 regions), and a polynomial function is used to estimate the scale value. For example, for power of two polynomial function, the scale value may be estimated using the equations below:

$$shift 0 = floorLog 2 ( denom )$$

$$round 0 = 1 ≪ shift 0 ≫ 1$$

$$normDiff = ( ( ( denom ≪ M ) + round 0 ) ≫ shift 0 ) \& ( ( 1 ≪ M ) - 1 ) ;$$

$$scale = a 2 * ( normDiff - b 2 ) ⋀ 2 + a 1 * ( normDiff - b 1 ) + a 0$$

Where a0, a1, a2, b1 and b2 are predefined values of the model for each region, and “\hat{ }” is power of 2 operation. The values of a0, a1 and a2 may be calculation using regression and MSE minimization. Parameter b2 may be defined in a way to minimize or reduce dynamic range of (normDiff-b2), for example b2 may be set to middle value of normDiffin that region.

To benefit from integer arithmetic, the parameters may be converted to integer value with specific bit precision. In that case, the scale value may be calculated as below where n1 and n2 are the number of precision bits for a1 and a2, respectively. In this case, these parameters may be quantized to the that precision bit. The value of n2 may be selected in a way that original (fractional) parameter of a2 is quantized to an integer value with minimum quantization error.

$$scale = \text{} a 2 * ( ( ( normDiff - b 2 ) ⋀ 2 ) ≫ n 2 ) + a 1 * ( ( normDiff - b 1 ) ≫ n 1 ) + a 0$$

The power of two term may have large dynamic range. To limit its dynamic range and required bits for the arithmetic operation, the power of two term may be shifted to right by a predefined number of shifts. In special case, this number of shifts may be set to bit depth of normDiff parameter. In general case, the right shift may be performed in two step, to keep the optimum precision for scale parameter calculation, using equation below

$$scale = \text{} ( ( a 2 * ( ( ( normDiff - b 2 ) ⋀ 2 ) ≫ n 21 ) ) ≫ n 22 ) + ( ( a 1 * ( ( normDiff - b 1 ) ≫ n 11 ) ) ≫ n 12 ) + a 0$$

In special case, b1 and b2 may have the same value and equal to b. In this case the scale value is calculated using the following equations. The value of b may be selected to optimize the value of a0, a1, or a2. For example, if the value of b for that region is selected carefully, a1 becomes a power of 2 (with positive or with negative power), and a result term a1*(normDiff−b) may be implemented by shift (to left or to right) operation. The other benefit of having of power of 2 value of a1 is reducing error of quantizing a1 to integer value

$$scale = \text{} a 2 * ( normDiff - b ) ⋀ 2 + a 1 * ( normDiff - b ) + a 0$$

As a result, when there are R=4 regions, and M=14, the input value denom is in the range of {16384, 32767} and accurate scale is in the range of {16384, 8192}, and the region value is calculated using the following equations

$$region = ( denom - 16384 ) ≫ ( M - floorLog 2 ( R ) )$$

The value of the region parameter may be calculated in different ways, where & is bitwise AND operation. For example

$$region = ( ( denom ≪ floorLog 2 ( R ) ) ≫ M ) \& ( ( 1 ≪ floorLog 2 ( R ) - 1 )$$

Then based on the region, proper parameters can be used for the calculation of scale.

For example, for the case of 4 regions (R=4), the parameters are as below:

$$a 2 [ 4 ] = \{ 182 , 99 , 60 , 39 \} ;$$

$$a 0 [ 4 ] = \{ 12348 , 11570 , 11926 , 13273 \} ;$$

$$b [ 4 ] = \{ 21850 , 23198 , 22434 , 19170 \} ;$$

$$region = r = ( denom - 16384 ) ≫ ( M - 2 )$$

$$normDiff = ( ( ( denom ≪ M ) + round 0 ) ≫ shift 0 ) \& ( ( 1 ≪ ( M + 1 ) ) - 1 ) ;$$

$$normDiff 2 -= b [ r ] ;$$

$$scale = ( ( a 2 [ r ] * ( ( normDiff 2 * normDiff 2 ) ≫ ( 10 ) ) ) ≫ ( 12 ) ) - ( normDiff 2 ≫ 1 ) + a 0 [ r ] ;$$

As another example, when there are R=8 regions, and M=14, the input value denom is in the range of {16384, 32767} and accurate scale is in the range of {16384, 8192}, and the scale value is estimated using the following equations

$$a 2 [ 8 ] = \{ 214 , 153 , 113 , 86 , 67 , 53 , 43 , 35 \} ;$$

$$a 0 [ 8 ] = \{ 12784 , 12054 , 11670 , 11583 , 11764 , 12195 , 12870 , 13782 \} ;$$

$$b [ 8 ] = \{ 21206 , 22336 , 23008 , 23176 , 22792 , 21808 , 20176 , 17850 \} ;$$

$$a 0 [ 4 ] = \{ 12348 , 11570 , 11926 , 13273 \} ;$$

$$b [ 4 ] = \{ 21850 , 23198 , 22434 , 19170 \} ;$$

$$region = r = ( denom - 16384 ) ≫ ( M - 2 )$$

$$normDiff = ( ( ( denom ≪ M ) + round 0 ) ≫ shift 0 ) \& ( ( 1 ≪ ( M + 1 ) ) - 1 ) ;$$

$$normDiff 2 -= b [ r ] ;$$

$$scale = ( ( a 2 [ r ] * ( ( normDiff 2 * normDiff 2 ) ≫ ( 10 ) ) ) ≫ ( 12 ) ) - ( normDiff 2 ≫ 1 ) + a 0 [ r ] ;$$

Value of parameters b and a2 for a given M may be calculated based on denom or normDiff values using a quadratic equation, for example

$$normDiff 3 = ( normDiff - 19314 )$$

$$b = ( - 288 * normDiff 3 * normDiff 3 ) ≫ 22 + normDiff 3 ≫ 1 + 22326$$

$$normDiff 4 = ( normDiff - 26569 )$$

$$a 2 = ( 4 * normDiff 3 * normDiff 3 ) ≫ 22 + normDiff 3 ≫ 7 + 55$$

Or, the intermedia value normDiff may be calculated using slightly different equation, so it is in the range of {0, 16383}, and the region value is calculated using the following equations

$$region = normDiff ≫ ( M - floorLog 2 ( R ) )$$

Then based on the region, proper parameters can be used for the calculation of scale.

For example, for the case of 4 regions (R=4), the parameters are as below:

$$a 2 [ 4 ] = \{ 182 , 99 , 60 , 39 ] ;$$

$$a 0 [ 4 ] = \{ 12348 , 11570 , 11926 , 13273 \} ;$$

$$b [ 4 ] = \{ 5466 , 6814 , 6050 , 2786 \} ;$$

$$normDiff = ( ( ( denom ≪ M ) + round 0 ) ≫ shift 0 ) \& ( ( 1 ≪ M ) - 1 ) ;$$

$$region = r = normDiff ≫ ( M - 2 )$$

$$normDiff 2 -= b [ r ] ;$$

$$scale = ( ( a 2 [ r ] * ( ( normDiff 2 * normDiff 2 ) ≫ ( 10 ) ) ) ≫ ( 12 ) ) - ( normDiff 2 ≫ 1 ) + a 0 [ r ] ;$$

As another example, when there are R=8 regions, and M=14, the input value denom is in the range of {16384, 32767} and accurate scale is in the range of {16384, 8192}, and the scale value is estimated using the following equations

$$a 2 [ 8 ] = \{ 214 , 153 , 113 , 86 , 67 , 53 , 43 , 35 \} ;$$

$$a 0 [ 8 ] = \{ 12784 , 12054 , 11670 , 11583 , 11764 , 12195 , 12870 , 13782 \} ;$$

$$b [ 8 ] = \{ 4822 , 5952 , 6624 , 6792 , 6408 , 5424 , 3792 , 1466 \} ;$$

$$a 0 [ 4 ] = \{ 12348 , 11570 , 11926 , 13273 \} ;$$

$$b [ 4 ] = \{ 21850 , 23198 , 22434 , 19170 \} ;$$

$$normDiff = ( ( ( denom ≪ M ) + round 0 ) ≫ shift 0 ) \& ( ( 1 ≪ M ) - 1 ) ;$$

$$region = r = normDiff ≫ ( M - 2 )$$

$$normDiff 2 -= b [ r ] ;$$

$$scale = ( ( a 2 [ r ] * ( ( normDiff 2 * normDiff 2 ) ≫ ( 10 ) ) ) ≫ ( 12 ) ) - ( normDiff 2 ≫ 1 ) + a 0 [ r ] ;$$

Values of parameters such as a2, a1, a0, and b for different M′ values may be calculated using scaling based on values of one specific M e.g., M=14;

$$a {0}^{′} = ( {M}^{′} > M ) ? ( a 0 ≪ ( {M}^{′} - M ) ) : ( a 0 ≫ ( M - {M}^{′} ) )$$

$$a {1}^{′} = ( {M}^{′} > M ) ? ( a 1 ≪ ( {M}^{′} - M ) ) : ( a 1 ≫ ( M - {M}^{′} ) )$$

$$a {2}^{′} = ( {M}^{′} > M ) ? ( a 2 ≪ ( {M}^{′} - M ) ) : ( a 2 ≫ ( M - {M}^{′} ) )$$

$${b}^{′} = ( {M}^{′} > M ) ? ( b ≪ ( {M}^{′} - M ) ) : ( b ≫ ( M - {M}^{′} ) )$$

Value of parameters b and a2 for a given M may be calculated based on denom or normDiff values using a quadratic equation, for example

$$normDiff 3 = ( normDiff - 2930 )$$

$$b = ( - 288 * normDiff 3 * normDiff 3 ) ≫ 22 + normDiff 3 ≫ 1 + 5942$$

$$normDiff 4 = ( normDiff - 10185 )$$

$$a 2 = ( 4 * normDiff 3 * normDiff 3 ) ≫ 22 + normDiff 3 ≫ 7 + 55$$

In an embodiment, the whole range of normDiff may be divided into unequal and a2, a1, a0, and b parameters may be optimized for each region to have implementation friendly with less truncation or quantization error. The range that is used to calculate those parameters for each may be overlapping regions. For example, for the case of M=14, when normDiff is in the range of {16383, 25472}, those parameters may be set to following values which can easily be implemented with low quantization error:

$$a 2 = 128 ( which is power of 2 can be implemented by shifting to right by 7 bits )$$

$$a 1 = - 1$$

$$a 0 = 17745$$

$$b = 14895$$

The Fixed parameters in the above equation might be one or few units smaller or larger, based on the way those values are quantized to integer values to optimize the division approximation error and/or software/hardware implementation.

The functionality described here can be used in various contexts. For example, the calculated output can be used to determine exact or estimated average sample value for a set of samples. In that case sum of sample values in the set can be used as the numerator nom and the number of samples in the set can be used as the denominator denom. As another example, the method can be used to determine filter coefficients in least squares sense. Some algorithms used in video and image coding require a matrix to be decomposed using, for example, the LDL decomposition or the Cholesky decomposition. Both of which require division operations to be performed to be able to perform the selected decomposition. In such cases substituting a full division operation with the method proposed here can lead to significant complexity reduction with minimal deviation from a mathematically optimal solution.

According to an embodiment, an output value approximating a result of a division operation between a numerator and denominator is determined using a scale value and a shift value, wherein the scale value is determined using an interpolation operation.

According to an embodiment, an output value approximating a result of a division operation between a numerator and denominator is determined using a scale value and a shift value, wherein the scale value is determined using polynomial interpolation.

According to an embodiment, an output value approximating a result of a division operation between a numerator and denominator is determined using a scale value and a shift value, wherein the scale value is determined using linear interpolation.

According to an embodiment, an output value approximating a result of a division operation between a numerator and denominator is determined using a scale value and a shift value, wherein the scale value is determined using an interpolation operation between at least two values which are determined based on a table look-up.

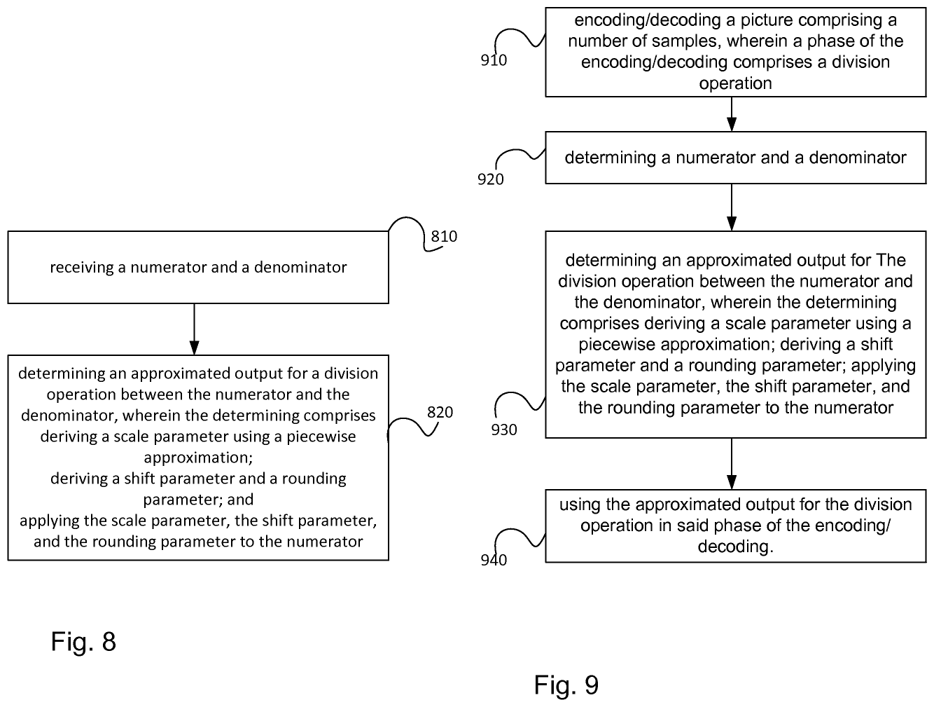

The method according to an embodiment is shown in FIG. 8. The method generally comprises receiving 810 a numerator and a denominator; and determining 820 an approximated output for a division operation between the numerator and the denominator, wherein the determining comprises deriving a scale parameter using a piecewise approximation; deriving a shift parameter and a rounding parameter, and applying the scale parameter, the shift parameter, and the rounding parameter to the numerator. Each of the steps can be implemented by a respective module of a computer system.

The method according to an embodiment is shown in FIG. 9. The method generally comprises encoding/decoding 910 a picture comprising a number of samples, wherein a phase of the encoding/decoding comprises a division operation; determining 920 a numerator and a denominator; determining 930 an approximated output for the division operation between the numerator and the denominator, wherein the determining comprises deriving a scale parameter using a piecewise approximation; deriving a shift parameter and a rounding parameter, applying the scale parameter, the shift parameter, and the rounding parameter to the numerator; and using 940 the division operation in said phase of the encoding/decoding. Each of the steps can be implemented by a respective module of a computer system.

An apparatus according to an embodiment comprises means for implementing any of the methods of FIG. 8 or 9. The means comprises at least one processor, and a memory including a computer program code, wherein the processor may further comprise processor circuitry. The memory and the computer program code are configured to, with the at least one processor, cause the apparatus to perform the method according to various embodiments.

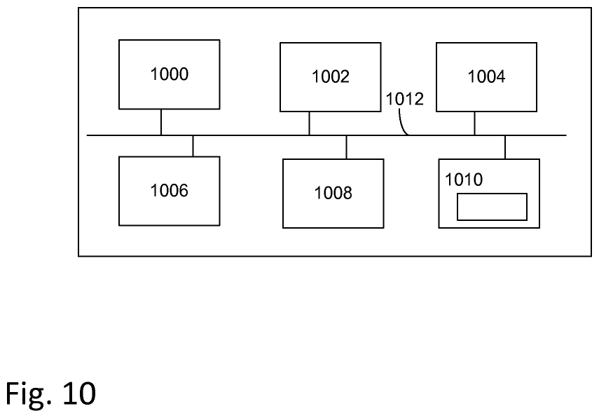

FIG. 10 illustrates an apparatus according to an embodiment. The generalized structure of the apparatus will be explained in accordance with the functional blocks of the system. Several functionalities can be carried out with a single physical device, e.g., all calculation procedures can be performed in a single processor if desired. A data processing system of an apparatus according to an example of FIG. 10 comprises a main processing unit 1000, a memory 1002, a storage device 1004, an input device 1006, an output device 1008, and a graphics subsystem 1010, which are all connected to each other via a data bus 1012. A client may be understood as a client device or a software client running on an apparatus.

The main processing unit 1000 is a processing unit arranged to process data within the data processing system. The main processing unit 1000 may comprise or be implemented as one or more processors or processor circuitry. The memory 1002, the storage device 1004, the input device 1006, and the output device 1008 may include other components as recognized by those skilled in the art. The memory 1002 and storage device 1004 store data in the data processing system 1000. Computer program code resides in the memory 1002 for implementing, for example, machine learning process. The input device 1006 inputs data into the system while the output device 1008 receives data from the data processing system and forwards the data, for example to a display. While data bus 1012 is shown as a single line it may be any combination of the following: a processor bus, a PCI bus, a graphical bus, an ISA bus. Accordingly, a skilled person readily recognizes that the apparatus may be any data processing device, such as a computer device, a personal computer, a server computer, a mobile phone, a smart phone or an Internet access device, for example Internet tablet computer.

The various embodiments can be implemented with the help of computer program code that resides in a memory and causes the relevant apparatuses to carry out the method. For example, a device may comprise circuitry and electronics for handling, receiving, and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-15. (canceled)

16. An apparatus, comprising at least one processor, memory including computer program code, the memory and the computer program code configured to, with the at least one processor, cause the apparatus to perform at least the following:
encoding or decoding a picture comprising a number of samples, wherein a phase of the encoding or decoding comprises a division operation;
determining a numerator and a denominator;
determining an approximated output for the division operation between the numerator and the denominator, wherein the determining comprises:
deriving a scale parameter using a piecewise approximation,
deriving a shift parameter and a rounding parameter; and
applying the scale parameter, the shift parameter, and the rounding parameter to the numerator; and
using the approximated output for the division operation in said phase of the encoding or decoding.

17. The apparatus according to claim 16, wherein to perform said phase of the encoding or decoding the apparatus upon execution is further caused to perform predicting at least one sample of the picture.

18. The apparatus according to claim 16, wherein to perform said phase of the encoding or decoding the apparatus upon execution is further caused to perform filtering.

19. The apparatus according to claim 16, wherein the apparatus upon execution is further caused to perform applying an additional shift parameter to the numerator.

20. The apparatus according to claim 16, wherein the apparatus upon execution is further caused to perform determining when the numerator, the denominator, the scale parameter and output parameter have different bit precision, whereupon the bit precision of the output and the scale parameter are used for determining the approximated output.

21. The apparatus according to claim 16, wherein the apparatus upon execution is further caused to perform determining the scale parameter using one of the following: an interpolation operation; a polynomial process; or a linear interpolation.

22. The apparatus according to claim 21, wherein the apparatus upon execution is further caused to perform determining the scale parameter using the interpolation operation between at least two values which are determined based on a table look-up.

23. The apparatus according to claim 22, wherein the apparatus upon execution is further caused to perform adjusting the scale parameter with a value to reduce a range of the denominator.

24. A method, comprising
encoding or decoding a picture comprising a number of samples, wherein a phase of the encoding or decoding comprises a division operation;
determining a numerator and a denominator;
determining an approximated output for the division operation between the numerator and the denominator, wherein the determining comprises
deriving a scale parameter using a piecewise approximation,
deriving a shift parameter and a rounding parameter, and
applying the scale parameter, the shift parameter, and the rounding parameter to the numerator; and
using the approximated output for the division operation in said phase of the encoding or decoding.

25. The method according to claim 24, wherein said phase of the encoding or decoding comprises predicting at least one sample of the picture.

26. The method according to claim 24, wherein said phase of the encoding or decoding comprises filtering.

27. The method according to claim 24, further comprising determining when the numerator, the denominator, the scale parameter and output parameter have different bit precision, whereupon the bit precision of the output and the scale parameter are used when determining the approximated output.

28. The method according to claim 24, further comprising determining the scale parameter using one of the following: an interpolation operation; a polynomial process; a linear interpolation.

29. The method according to claim 28, further comprising determining the scale parameter using the interpolation operation between at least two values which are determined based on a table look-up.

30. The method according to claim 24, comprising applying an additional shift parameter to the numerator.

31. The method according to claim 24, further comprising adjusting the scale parameter with a value to reduce a range of the denominator.

32. A non-transitory computer-readable medium comprising program instructions stored thereon which, when executed with at least one processor, cause the at least one processor to:
encode or decode a picture comprising a number of samples, wherein a phase of the encoding or decoding comprises a division operation;
determine a numerator and a denominator;
determine an approximated output for the division operation between the numerator and the denominator, wherein the determining comprises
deriving a scale parameter using a piecewise approximation,
deriving a shift parameter and a rounding parameter, and
applying the scale parameter, the shift parameter, and the rounding parameter to the numerator; and
using the approximated output for the division operation in said phase of the encoding or decoding.
